(19) United States
(12) Patent Application Publication
(10) Pub. No.: US 2009/0019619 A1
(43) Pub. Date: Jan. 22, 2009

(54) FRAGRANT COLLAR STAYS

(76) Inventor: Michael Shweky, Oakhurst, NJ (US)

Correspondence Address: Leason Ellis LLP, 81 Main Street, Suite 100, White Plains, NY, 10601, US

(21) Appl. No.: 11/781,029

(22) Filed: Jul. 20, 2007

(51) Int. Cl. A41D 27/06; B42D 15/00; B65D 71/00

(52) U.S. Cl. 2/258; 206/223; 283/56

(57) ABSTRACT

A collar stay according to one embodiment includes a body carrying a fragrance so as to impart a pleasant scent to the collar stay that can be experienced over a period of time. In another embodiment, a retail article includes one or more pairs of collar stays and a package for holding the collar stays. A liquid fragrance is sealed within an interior of the package and in contact with the collar stays so as to impregnate the collar stays with a fragrant smell.

### TECHNICAL FIELD

The present invention relates to wearing apparel and holding their shape and in particular, to a collar stiffening device (collar stay) that provides sufficient stiffness and incorporates a pleasing fragrant smell and to retail packaging and promotional material containing the same.

### BACKGROUND

When shirts or dresses or other clothing items are packed in luggage or the like for traveling purpose, the clothing articles including the collars thereof become compressed and wrinkled, which is evident upon removal either for immediate use or hanging in closets. In addition, when shirts or dresses are hung on hangers, the collars become compressed and are subject to creasing from close packing. While some wrinkling of skirts and dresses may be acceptable, it is the wrinkling of the collars that is most noticeable.

Open collar shirts that are made of a knitted fabric material are comfortable to wear; however, the collars of these types of shirts tend to lie irregularly or tend to curl as a result of washing, drying, or exposure to high humidity levels. While laundering and ironing can remedy the situation, the ends of the shirt collars tend to still result in curling. In the past, these collar appearance problems have been addressed through the use of collar stiffening devices of various shapes. Typically, the article of clothing, such as a collared shirt, includes pockets that are located at the edges of the collar for receiving plastic stays.

While collar stiffeners have been satisfactory in terms of their basic functionality, it is desirable to add additional functionality to such existing collar stiffeners.

### SUMMARY

A collar stay according to one embodiment includes a body carrying a fragrance so as to impart a pleasant scent to the collar stay that can be experienced over a period of time.

In another embodiment, a collar stay is defined by an elongated body that is formed of a material that absorbs a liquid fragrance that impregnates the body so as to provide a pleasant smelling experience when the collar stay is worn in a collar.

In another embodiment, a retail article according to the present invention includes one or more pairs of collar stays and a package for holding the collar stays. A liquid fragrance is sealed within an interior of the package and in contact with the collar stays so as to impregnate the collar stays with a fragrant smell.

In another embodiment, a retail article includes a bandolier of collar stays that are detachable from one another and a package for holding the collar stays. The article also includes a liquid fragrance that is sealed within an interior of the package and in contact with the bandolier of collar stays so as to impregnate the collar stays with a fragrant smell.

An advertising medium according to one embodiment includes a printed substrate having an illustration of a collared shirt formed thereon. The collar portion of the shirt is depicted by a pair of collar sections that can be lifted relative to the underlying substrate to which they are each attached at one end so as to each expose an underlying first area of substrate. The advertising medium also includes a pair of fragrant collar stays disposed within the first areas of the printed substrate and accessible when the respective collar sections are lifted relative to the printed substrate.

These and other aspects, features and advantages shall be apparent from the accompanying Drawings and description of certain embodiments of the invention.

### BRIEF DESCRIPTION OF THE DRAWINGS

FIG. 1 is a top plan view of a pair of fragrant collar stays according to a first embodiment of the present invention;

FIG. 2 is a top plan view of a fragrant collar stay, according to a second embodiment, that includes a coating of fragrant material;

FIG. 3 is a cross-sectional view taken along the line 3-3 of FIG. 2;

FIG. 4 is a top plan view of a fragrant collar stay, according to a third embodiment, that includes a scented adhesive;

FIG. 5 is a top plan view of a fragrant collar stay, according to a fourth embodiment, that includes a rupturable packet of a liquid fragrance;

FIG. 6 is a cross-sectional view taken along the line 6-6 of FIG. 5;

FIG. 7 is a top plan view of a fragrant collar stay, according to a fifth embodiment, that includes an insert formed of a fragrant material;

FIG. 8 is a cross-sectional view taken along the line 8-8 of FIG. 7;

FIG. 9 is top plan view of a fragrant collar stay, according to a sixth embodiment, that includes a layer of fragrant material;

FIG. 10 is a cross-sectional view taken along the line 10-10 of FIG. 9;

FIG. 11 is a top plan view, partially broken away, illustrating a package of fragrant collar stays according to one embodiment;

FIG. 12 is a top plan view of a package of fragrant collar stays according to another embodiment in a sealed position;

FIG. 13 is a top plan view of the package of FIG. 12 in an open position;

FIG. 14 is a top plan view of an advertising medium in a closed, sealed position;

FIG. 15 is a top plan view of the advertising medium of FIG. 14 in a closed position; and

FIG. 16 is a top plan view of a bandolier of fragrant collar stays.

### DETAILED DESCRIPTION OF CERTAIN EMBODIMENTS OF THE INVENTION

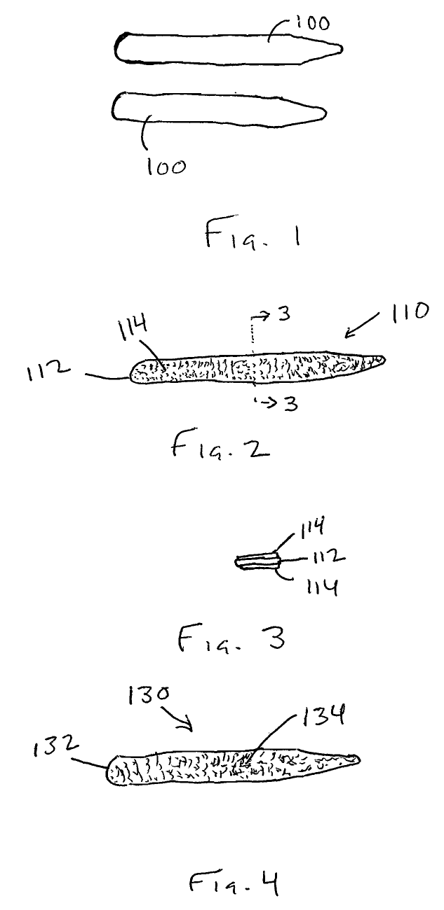

FIG. 1 is a top plan view of a pair of fragrant/scented collar stays 100 in accordance with a first embodiment of the present invention. Each of the collar stays 100 is constructed so that it has a specific fragrance or scent associated therewith and therefore, when the collar stays 100 are inserted into pockets formed as part of the collar of an article of clothing or are otherwise carried by the article of clothing, the wearer experiences a pleasing fragrant smell over an extended period of time. The fragrant collar stays 100 can either act as a substitute to the conventional spraying of cologne or perfume on the skin or can supplement an earlier cologne or perfume application. In other words, the fragrant collar stays 100 can be inserted into the collar pockets several hours after the initial application of the cologne or perfume to the wearer's skin.

The collar stays 100 can be formed of a number of different materials so long as the materials are capable of maintaining the fragrant smell over a period of time. For example, the collar stays 100 can be formed of a plastic material (which can be scented); a woven hard fabric material or a thick paper stock material (e.g., cardboard).

The collar stays 100 are shaped and dimensioned so that they can be worn with conventional collars. For example, the collar stays 100 can be sized and dimensioned to be received into collar pockets formed on the underside of a collar.

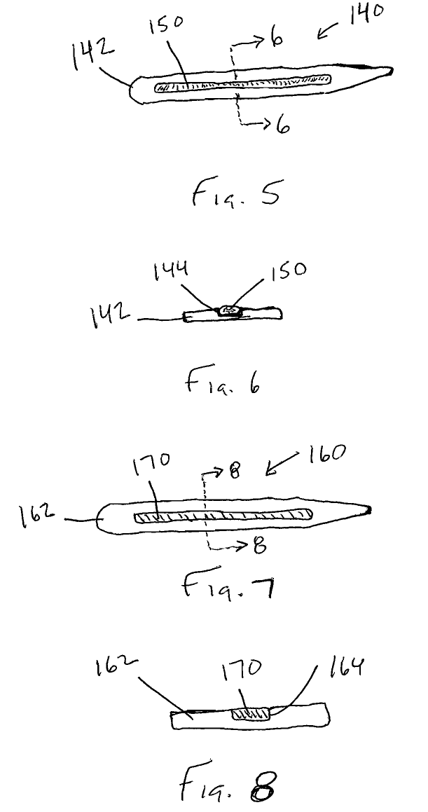

FIG. 2 is top plan view of a collar stay 110 according to a second embodiment of the present invention and FIG. 3 is a cross-sectional view of the stay 110. The collar stay 110 includes a body 112 with opposing first and second surfaces or faces. The collar stay 110 includes a scented coating 114 that is disposed over at least one of the first and second surfaces. The scented coating 114 is formed of a material that results in a substantially hard coated layer 114 being formed on the body 112. The coating 114 is therefore formed so that it cannot be easily removed, such as by peeling the coating 114 off the body 112. In addition, the material used to form the coating 114 must be able to absorb and retain the fragrance/scent so that it can be released over a period of time. For example, the coating 114 can be formed of a porous material.

FIG. 4 is top plan view of a collar stay 130 according to a third embodiment of the present invention. The collar stay 130 includes a body 132 with opposing first and second surfaces or faces. The collar stay 130 includes a scented adhesive 134 that is disposed over at least one of the first and second surfaces. For example, the scented adhesive 134 can be in the form of a scented glue or glue-like substance. The scented adhesive 134 can be applied in different locations (spots) along one or more surfaces of the body 132 or can be disposed as a layer over one surface of the body 132. As with all of the embodiments, the adhesive 134 is capable of retaining and releasing the fragrance over a period of time.

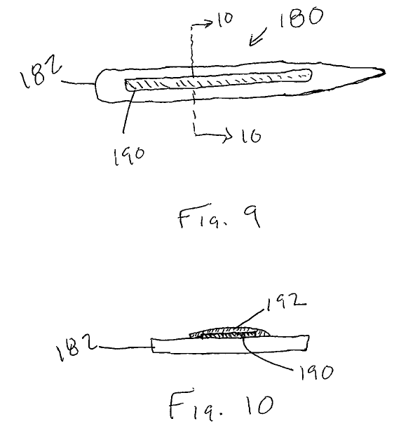

FIG. 5 is top plan view of a collar stay 140 according to a fourth embodiment of the present invention and FIG. 6 is a cross-sectional view thereof. The collar stay 140 includes a body 142 with opposing first and second surfaces or faces. The collar stay 140 includes a fragrance capsule or packet 150 that is incorporated into the body 142. The fragrance capsule 150 is formed of a rupturable material, such as a thin plastic structure, that is easily ruptured by flexing the collar stay 140. For example, one of the surfaces of the body 142 can have a recess (recessed compartment) 144 that receives and holds the fragrance capsule 150. When the user desires to release the fragrance and impregnate the collar stay 140 with fragrance, the user simply either flexes the stay 140 a sufficient degree to cause the capsule 150 to rupture or the user simply directly ruptures the capsule 150. Upon rupturing of the capsule 150, the fragrance contained therein is released over the stay 140 where it is absorbed resulting in impregnation of the collar stay 140 with the fragrance.

FIG. 7 is top plan view of a collar stay 160 according to a fifth embodiment of the present invention and FIG. 8 is a cross-sectional view thereof. The collar stay 160 includes a body 162 with opposing first and second surfaces or faces. The collar stay 160 includes at least one recessed compartment (indented portion) 164 that is formed in one or more of the first and second surfaces or faces. An insert 170 that is formed of a scented material is disposed within the recessed compartment 164. In this manner, the body 162 can be reusable in that once the fragrant smell of one insert 170 fades over time, the user can simply remove the insert 170 and then replace it with another insert 170 that can have the same fragrance or it can have another fragrant smell.

FIG. 9 is top plan view of a collar stay 180 according to a sixth embodiment of the present invention and FIG. 10 is a cross-sectional view thereof. The collar stay 180 includes a body 182 with opposing first and second surfaces or faces. The collar stay 180 incorporates a scented vaporizing mechanism 190 which can be in the form of a material (layer of material) that contains odiferous molecules that are vaporized from a solid state under certain conditions, such as exposure to atmosphere, heat, etc. For example, the material 190 can be covered with a release or cover layer 192 that can easily be peeled off so as to cause the scented material 190 to be exposed to atmosphere. The edges of the cover 192 can include an adhesive compound and the cover 192 is formed of a material that seals the freshness and scent of the material 190 until removal of the cover 192 as by peeling the cover 192 from the body 182, thereby exposing the material 190.

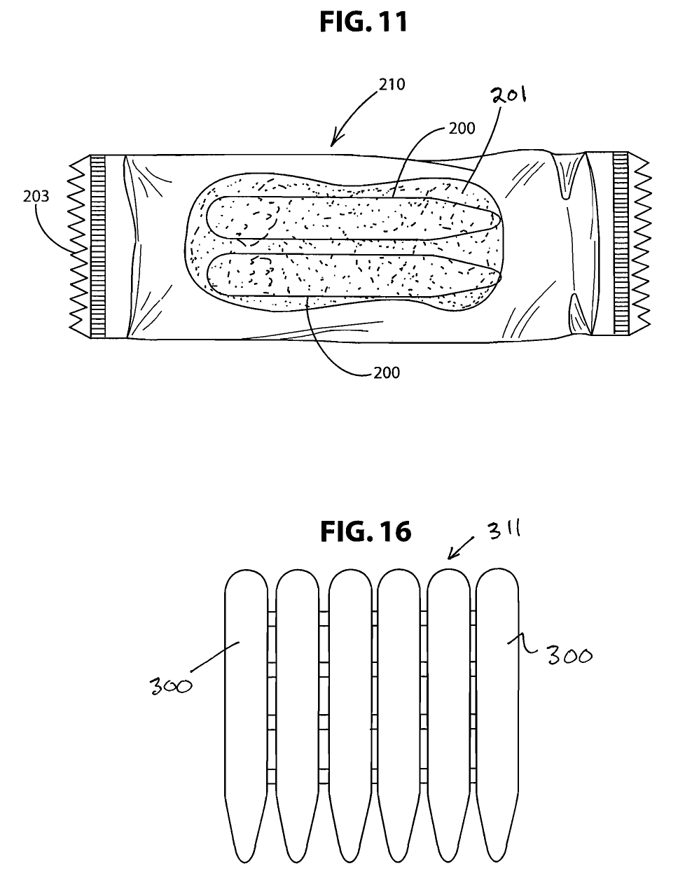

FIG. 11 is a top plan view, partially broken away, of a collar stay 200 and packaging according to one embodiment. In this embodiment, one or more pairs of collar stays 200 are sealed in a package 210. The package 210 is formed of a material that can seal liquid 201 within its interior, while at the same time be robust enough to withstand being carried in a bag, pocketbook, etc. For example, the package 210 can be formed of a flexible foil material or thin plastic material. The ends of the package 210 can be perforated or jagged, as shown at 203, in order to assist the user in opening the package 210 and removing the scented collar stays 200.

The fragrance/scent is in the form of a liquid perfume or cologne 201 that is injected into the interior of the package 210 so that the liquid fragrance contacts and baths the collar stays 200. The amount of liquid will be sufficient to contact at least a substantial surface area of the collar stays 200 but not be excessive so that once the package 210 is open, liquid fragrance runs out of the package over the user.

Preferably, the packaging 210 includes a label (not shown) identifying the scent, e.g., identification of the brand of perfume/cologne that is contained in the package 210 (e.g., Calvin Klein Eternity). This permits the user to easily choose the desired fragrance from amongst a number of packages 210 that could contain different scents. It will be appreciated that a number of individual packages 210 can be arranged and marketed in a single box. The box can contain multiple packages 210 of a single fragrance or it can be a “sampler” box in that it contains a number of packages 210 that contain different fragrances. For example, if one clothing company or cosmetic company has a line of different perfumes or colognes, the company can market all of their different perfumes/colognes by including within the box at least one package of collar stays impregnated with each perfume or cologne. This serves as an excellent promotion means in that the fragrant collar stays serve as a sampler for the company's perfumes and colognes with the goal being that once the wearer has a pleasant experience with the fragrant collar stays, the user will purchase a bottle of the perfume or cologne.

The stays 200 are formed of a material, such as thick paper stock, that can absorb the liquid fragrance that immerses the stays 200 inside the package 210. Conventional packaging and package sealing technology is used in that the stays 200 can be inserted into an open end of the package 200, a predetermined amount of fragrance is then added and then the open end is sealed.

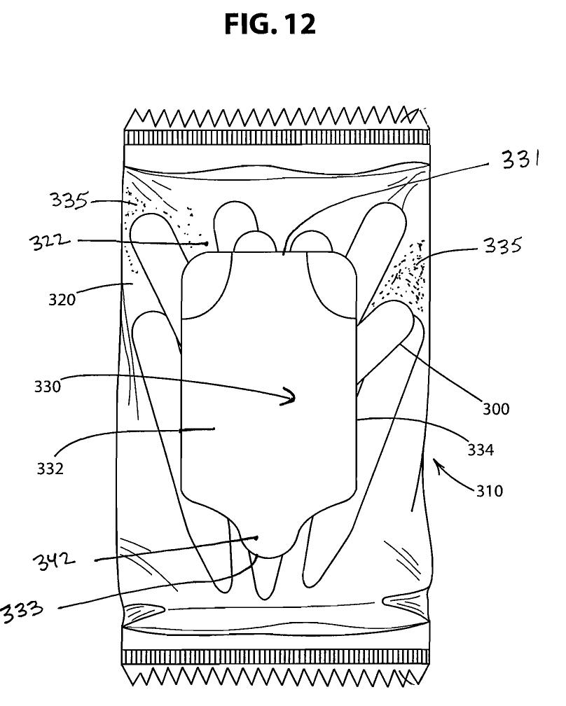

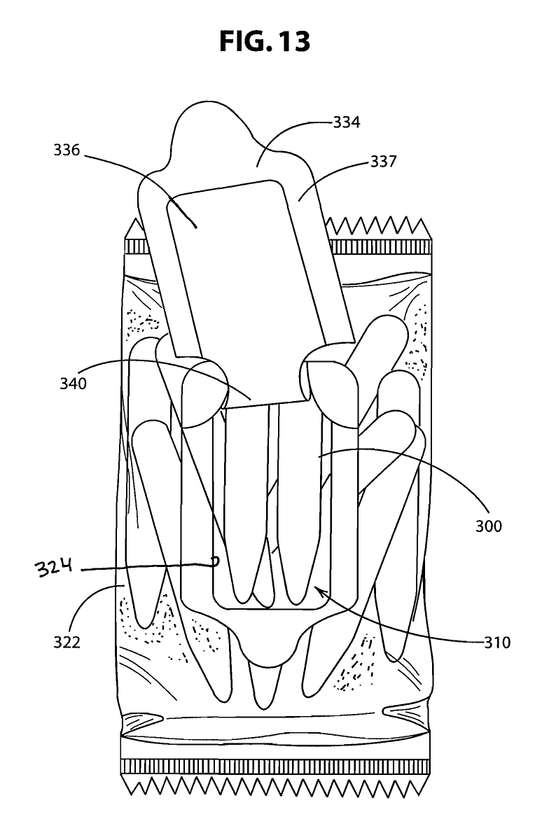

FIGS. 12-13 illustrate a fragrant collar stay package and delivery system according to another embodiment. More specifically, in this embodiment, a plurality of fragrant collar stays 300 are disposed and sealed within a package 310. The fragrant collar stays 300 can be detached and separate from one another as shown in FIGS. 12 and 13 or in another embodiment shown in FIG. 16, the collar stays 300 are in the form of a bandolier structure 311 (collar stays 300 detachably connected in series).

In this embodiment, the package 310 is meant to be reusable in that it includes a main package body 320 made of a material that seals the liquid fragrance therein and in contact with the collar stays 300. One face or surface 322 of the package body 320 includes an opening 324 formed therein that permits access to the interior of the package 310. The opening 324 is sized and shaped so that the collar stays 300 can be freely removed from the interior of the package 310 through the opening 324. In the illustrated embodiment, the opening 324 has an oblong or rectangular shape.

The package 310 is reusable due to the inclusion of a reusable seal member or label 330. The label 330 has a first side 332 and an opposite second side 334 and has dimensions greater than the opening 324 so that when the label 330 is attached to the surface 322, the entire opening 324 is covered and sealed by the label 330. The first side 332 of the label 330 is the side that faces out and is visible to the user. This first side 332 thus contains indicia, such as the name of the fragrance and other brand and marketing information. As shown in FIG. 13, the other side 334 of the label 330 is the side that seals the opening 324. This side 334 includes a first section 336 that has complementary shape to the opening 324 and is designed to be placed over the opening 324 when the label 330 is sealingly, yet detachably, attached to the surface 322. The first section 336 can be formed of a thin layer of foil, while the remaining sections 337 of the label 330 can be formed of a thin plastic material since foil tends to create a better seal with the package body 320. The foil material used for the first section 336 can be the same or a similar material as the material that is used to form the package 310.

The second section 337 that surrounds the first section 336 includes a layer of adhesive of the type that permits the label 330 to be reused, thereby permitting the package 310 to be resealed. In order words, the adhesive layer that surrounds at least a portion of the first section 336 allows the label 330 to be lifted for exposing the opening 324 and accessing the collar stays 300 and then resealed against the surface 322 so as to prevent any of the liquid fragrance from leaking from opening 324 and to ensure the collar stays 300 remain immersed in a sufficient amount of liquid fragrance 335.

Preferably, the label 330 include a fixed end 331 that is securely attached or bonded to the surface 322 in a manner in which the lifting of the other end 333 of the label 330 does not cause the fixed end 331 to separate from the surface 322. Thus, the fixed end 331 is permanently attached to the surface 322. A hinge element 340 is provided at or proximate the fixed end 331 to permit the lifting of the label 330 to expose the opening 324. To assist the user, the other end 333 can include a peel back portion or peel back tab 342 that the user grasps in order to easily lift and break the seal between the label 330 and surface 322. The use of fixed end 331 and hinge element 340 also ensures that the first section 336 (foil) properly aligns with and covers the opening 324.

By providing a bandolier of collar stays 300, the user simply can open the package 310 by lifting the pull tab 333 to expose opening 324 and then retrieving a preselected number of collar stays 300. In the case of when the stays 300 are in the bandolier form 311 of FIG. 16, the user simply separates the stays 300 from the bandolier structure 311 outside of the opening 324 and then places the unused ones back into the package 310. After the collar stays 300 have been removed, the package 310 is resealed with label 330 and the remaining collar stays 300 remain fresh and fragrant in the sealed package 310.

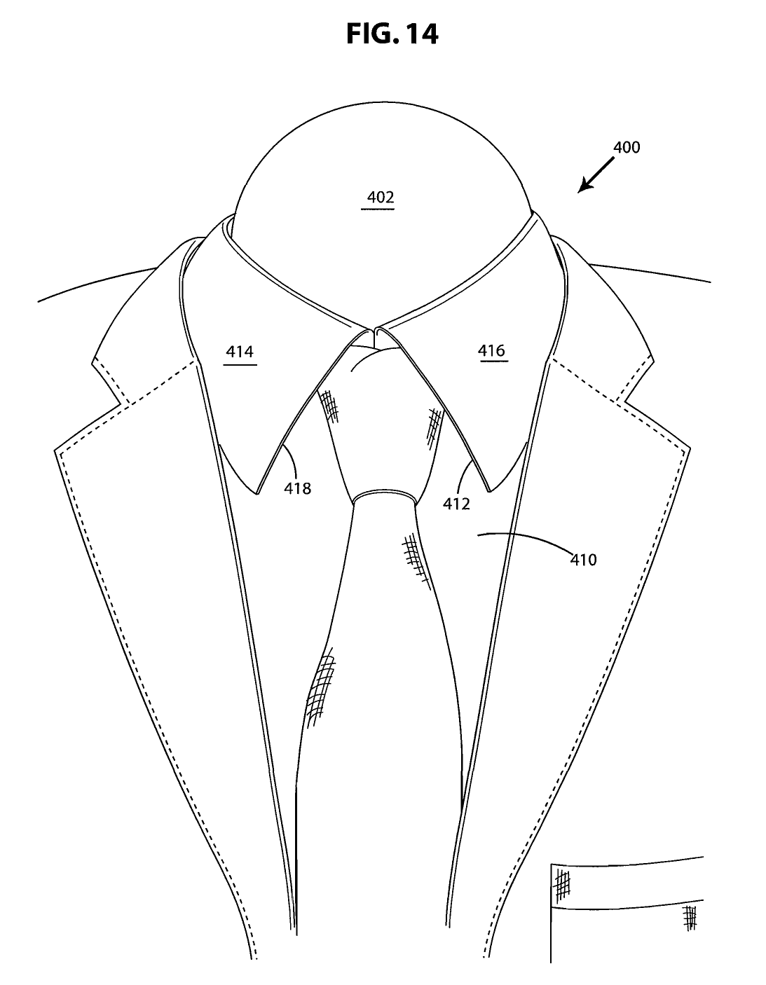

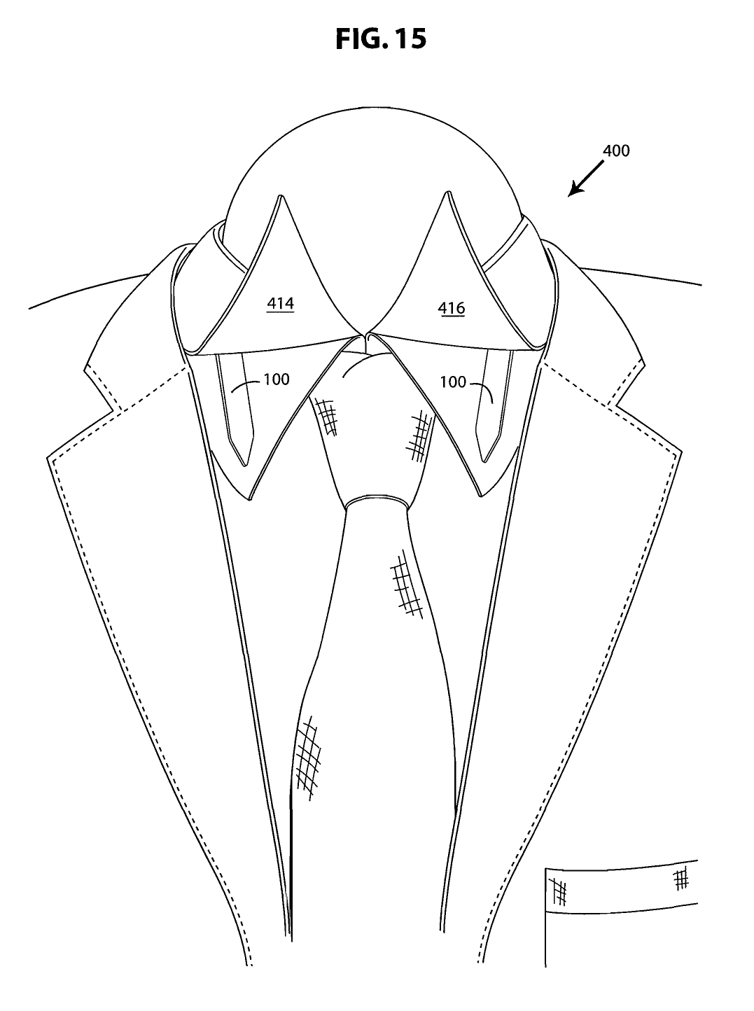

In another embodiment, the fragrant collar stays can be incorporated into promotional materials. For example, a printed advertisement 400 shown in FIGS. 14-15 includes an illustration of an article of clothing 410, such as a collared shirt or collared shirt with tie and suit combination. One section 402 of the advertisement, such as an area above the neck and collar 412 of the shirt 410 includes promotional indicia, such as a name of a perfume or cologne or even a store's name or the name of a clothing line. The advertisement 400 is constructed so that the two points 414, 416 of the collar 412 can be lifted up to reveal the fragrant collar stays 100. More specifically, the points 414, 416 of the collar 412 are paper sections that are fixed at one end and are sealed along their peripheral edges to the underling paper advertisement 400 so as seal the underlying fragrant collar stays 100. When the user (prospective consumer) wishes to experience the perfume or cologne, the user simply lifts a free edge (peel tab) 418 of the collar points 414, 416 to break the seal and expose the fragrant collar stays 100. The user not only experiences the perfume or cologne but also, at least in one embodiment, can remove the collar stays 100 and use them. For example, the collar stays 100 can be detachably attached to the printed advertisement in a number of different ways including the use of an adhesive that permits easy detachment of the collar stays 100 or the collar stays 100 can be inserted into little paper pockets that securely hold the collar stays. Alternatively, the collar stays 100 can be permanently fixed to the printed advertisement using a different type of adhesive.

In this manner, the advertisement 400 can serves as an effective printed promotional vehicle by allowing the user to experience the smell of a perfume or cologne in a new unique manner and one which is practical and useful since unlike conventional printed advertisements which are discarded, the collar stays 100 can be used by the viewer of the advertisement. In addition, the advertisement 400 also provides a means for advertising the sale of the collar stays 100 themselves. For example, the advertisement 400 can include a statement “You can experience the fresh, new ABC perfume by buying fragrant collar stays at XYZ store.”

The advertisement 400 is not limited to being a single page printed ad, as in a magazine, but instead can be a large cardboard display that can be placed on a counter in a cosmetic section of a store and underneath the liftable collar portions, there can be multiple fragrant collar stays 100 so that a number of prospective purchasers can experience the perfume or cologne by removing one collar stay.

In addition, the advertising medium can be in the form of mailers, billboards and when it is not necessary to offer sample fragrant stays, the advertising can be done through electronic channels, such as TV and the internet.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A collar stay comprising:
a body carrying a fragrance so as to impart a pleasant scent to the collar stay that can be experienced over a period of time.

2. The collar stay of claim 1, wherein the fragrance is incorporated in a solid material that is disposed along one or more surfaces of the body.

3. The collar stay of claim 2, wherein the solid material comprises a layer that coats the one or more surfaces of the body.

4. The collar stay of claim 2, wherein the solid material comprises an adhesive material that is disposed in one more locations along the one or more surfaces of the body.

5. The collar stay of claim 2, wherein the solid material comprises an insert that is securely disposed and held within a recessed compartment formed along one surface of the body.

6. The collar stay of claim 2, wherein the solid material comprises a layer that is disposed along one surface of the body and contains odiferous molecules that are vaporized from a solid state under prescribed conditions, the layer being covered with a release cover, the cover being formed of a material that seals the freshness and scent of the solid material until removal of the cover.

7. The collar stay of claim 6, wherein the prescribed conditions include exposure of the solid material to atmosphere and exposure of the solid material to heat.

8. A collar stay comprising:
an elongated body that is formed of a material that absorbs a liquid; and
a liquid fragrance that impregnates the body so as to provide a pleasant smelling experience when the collar stay is worn.

9. An article comprising:
one or more pairs of collar stays;
a package for holding the collar stays; and
a liquid fragrance that is sealed within an interior of the package and in contact with the collar stays so as to impregnate the collar stays with a fragrant smell.

10. An article comprising:
a bandolier of collar stays that are detachable from one another;
a package for holding the collar stays; and
a liquid fragrance that is sealed within an interior of the package and in contact with the bandolier of collar stays so as to impregnate the collar stays with a fragrant smell.

11. The article of claim 10, wherein the collar stays are formed of a material that can absorb the liquid fragrance.

12. The article of claim 10, wherein the collar stays are formed of a paper material or a porous plastic material.

13. The article of claim 10, wherein the package includes an opening to permit access to and removal of the collar stays and a peelable cover that seals the opening to ensure freshness and maintain the liquid fragrance in the interior of the package, the cover being a resealable cover in that after each time the cover is lifted to expose the opening, it can be resealed to a side of the package.

14. The article of claim 13, wherein the cover includes a first foil section that is disposed over the opening when the cover is in a closed position and a surrounding section that includes an adhesive material to cause the cover to seal to the package around the opening.

15. The article of claim 13, wherein a first end of the cover is fixedly attached to the package with a hinge being formed near the first end to permit the cover to be lifted to expose the opening and a second end of the cover includes a peel tab to assist the user in lifting the cover to expose the opening and remove the fragrant collar stays.

16. The article of claim 10, wherein the liquid fragrance comprises a perfume or cologne.

17. The article of claim 10, wherein the package is formed of a foil material.

18. The article of claim 10, wherein the collar stays are formed of a paper material and are detachably attached to one another along perforated lines.

19. An advertising medium comprising:
a printed substrate having an illustration of a collared shirt formed thereon, wherein the collar portion of the shirt is depicted by a pair of collar sections that can be lifted relative to the underlying substrate to which they are each attached at one end so as to each expose an underlying first area of substrate; and
a pair of fragrant collar stays disposed within the first areas of the printed substrate and accessible when the respective collar sections are lifted relative to the printed substrate.

20. The advertising medium of claim 19, wherein the printed substrate and the collar sections are formed of a paper material.

21. The advertising medium of claim 19, wherein each collar section is initially in a sealed position where it lays substantially flat against the printed substrate and the underlying fragrant collar stay is sealed between the collar section and the printed substrate, the collar section being movable to an open position where the seal between the collar section and the printed substrate is broken and the fragrant collar stay is exposed.

22. The advertising medium of claim 19, wherein the fragrant collar stay is permanently attached to the printed substrate.

23. The advertising medium of claim 19, wherein the fragrant collar stay is detachably attached to the printed substrate.

24. The advertising medium of claim 19, wherein the printed substrate is a page of a printed publication or a standalone cardboard display for use on a countertop.
